(19) United States
(12) Patent Application Publication
(10) Pub. No.: US 2004/0265730 A1
(43) Pub. Date: Dec. 30, 2004

(54) Photosensitive composition and production processes for photosensitive film and printed wiring board

(76) Inventors: Hiroshi Takahashi, Ichihara-shi (JP); Nobuo Uotani, Chiba (JP); Toshio Koshikawa, Ichihara-shi (JP); Tsuyoshi Katoh, Ichihara-shi (JP); Kunio Matsuki, Mobara-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/493,101

(22) PCT Filed: Dec. 3, 2002
(86) PCT No.: PCT/JP02/12656

Related U.S. Application Data
(60) Provisional application No. 60/337,148, filed on Dec. 10, 2001.

(30) Foreign Application Priority Data
Dec. 3, 2001 (JP) 2001-369065

(51) Int. Cl. G03C 1/76

(52) U.S. Cl. 430/270.1; 430/311

(57) ABSTRACT

The object is to provide a photosensitive resin which is improved in the environmental problem or working environment problem, reduced in the load on a production apparatus and enhanced in the safety during transportation or storage while maintaining the resolution, etching resistance and low cost of conventional liquid photosensitive resin compositions. Another object is to provide a production process of a printed wiring board, where the non-uniformity of film thickness or liquid dripping at the time of coating a photosensitive resin on a printed board by a dipping method is reduced and high quality and excellent productivity are ensured. The objects were achieved by using a photosensitive resin composition comprising a specific compound having two or more polymerizable unsaturated bonds within one molecule, a photopolymerization initiator, water, and a thixotropic agent, and, if necessary, an amine.

### CROSS-REFERENCE TO RELATED APPLICATIONS

This application claims the benefit pursuant to 35 U.S.C. §119(e)(1) of U.S. Provisional Application, No. 60/337,148 filed Dec. 10, 2001.

### TECHNICAL FIELD

The present invention relates to a photosensitive resin composition and a process for producing a printed wiring board using the composition. More specifically, the present invention relates to an aqueous photosensitive resin composition, a process for forming a photosensitive resin film on a printed board using the composition, and a process for producing a printed wiring board.

### BACKGROUND ART

The printed wiring board has been heretofore manufactured in such a manner that a photosensitive film is formed on an insulating substrate having thereon an electrically conductive metal layer such as copper foil, the film is exposed to a desired pattern and then developed with water or an alkaline solution, the electrically conductive metal layer except for the pattern is etched with an etching solution and thereafter, the pattern is peeled off to form a desired wiring.

The photosensitive resin used therefor is usually dissolved in an organic solvent having high volatility before use and there is a fear of adverse effect on human body or environment. Furthermore, due to high inflammability, use and storage thereof are regulated by the Japanese Fire Service Law or careful handling is necessary.

The method for forming a film of the photosensitive resin composition includes a screen printing method, a roll coater method, a spray method and an electrodeposition method, however, these have a problem, for example, the screen printing method is low in the resolution and the productivity, the roll coater method is difficult to apply to a thin and flexible printed board, the spray method is poor in the efficiency and the electrodeposition method costs highly.

Water-soluble photosensitive resin compositions or water-dispersing photosensitive resin compositions for a printed wiring board are disclosed in Unexamined Published Japanese Patent Application No. Hei 6-93221, Japanese Patent No. 3040202, Unexamined Published Japanese Patent Application No. Hei 6-184269, Unexamined Published Japanese Patent Application No. Hei 6-258832, and Unexamined Published Japanese Patent Application No. Hei 8-328251, however, there are problems that the film quality is bad, the sensitivity and resolution are insufficient, the wettability to a printed board is poor, the storage stability is low, the pattern swells at the development and the development cannot be performed with water or a dilute alkaline solution. Furthermore, when the photosensitive resin is coated by a dipping method, the coating uniformity is bad with thin upper part and thick lower part in any case or liquid dripping takes place from the lower end portion of the board.

Photosensitive resin compositions for a printed wiring board, which are applied by a dipping method, are disclosed in Unexamined Published Japanese Patent Application No. Sho 60-262813, Unexamined Published Japanese Patent Application No. Hei 2-135451, Unexamined Published Japanese Patent Application No. Hei 4-218049, Unexamined Published Japanese Patent Application No. Hei 5-204140, Unexamined Published Japanese Patent Application No. Hei 5-273760, Unexamined Published Japanese Patent Application No. Hei 6-180499, Unexamined Published Japanese Patent Application No. Hei 6-244533, Unexamined Published Japanese Patent Application No. Hei 9-157574 and Unexamined Published Japanese Patent Application No. Hei 10-104830, however, these are disadvantageous in that the composition is organic solvent-type, the film quality is bad, the sensitivity and resolution are insufficient, the film thickness is large due to high viscosity and the storage stability is poor because the filler precipitates.

A method of forming a photosensitive resin film by attaching a photosensitive film on a printed board is known, however, this method suffers from poor resolution due to large thickness of the film and high cost.

### DISCLOSURE OF INVENTION

The present invention was developed with an object of providing a photosensitive resin which is improved in the environmental problem or working environment problem, reduced in the load on a production apparatus and enhanced in the safety during transportation or storage while maintaining the resolution, etching resistance and low cost of conventional liquid photosensitive resin compositions.

One object of the present invention is to provide a production process of a printed wiring board, where the non-uniformity of film thickness or liquid dripping at the time of coating a photosensitive resin on a printed board by a dipping method is reduced and high quality and excellent productivity are ensured.

Under these circumstances, the present inventors have made extensive investigations, as a result, it has been found that the above-described problems can be overcome by the following specific resin composition and the process for forming a film of the resin composition. The present invention has been accomplished based on this finding.

(I) A photosensitive resin composition comprising

a compound (A) having two or more polymerizable unsaturated bonds within one molecule,

a photopolymerization initiator (B), water (C) and

a thixotropic agent (D).

(II) The photosensitive resin composition as described in (I), wherein a part or the whole of the compound (A) is a compound (A′) having one or more carboxylic groups within one molecule and having two or more polymerizable unsaturated bonds within one molecule.

(III) The photosensitive resin composition as described in (II), wherein the acid value of the compound (A′) is from 5 to 200 mgKOH/g.

(IV) The photosensitive resin composition as described in any one of (I) to (III), which contains, as the compound (A), a compound (A″) not having a carboxylic group and having two or more polymerizable unsaturated bonds within one molecule and a compound (A′) having one or more carboxylic group within one molecule and having two or more polymerizable unsaturated bonds within one molecule.

(V) The photosensitive resin composition as described in (IV), wherein the ratio of the compound (A″) to the compound (A′) is from 1:20 to 1:1.

(VI) The photosensitive resin composition as described in any one of (I) to (V), wherein the content of the compound (A) is from 5 to 50 mass % of the photosensitive resin composition.

(VII) The photosensitive resin composition as described in any one of (I) to (VI), which contains a stabilizing agent (E).

(VIII) The photosensitive resin composition as described in (VII), wherein the stabilizing agent (E) is a water-soluble polymer.

(IX) The photosensitive resin composition as described in (VIII), wherein the water-soluble polymer is selected from the group consisting of polyvinyl alcohols, modified polyvinyl alcohols, and hydroxyethyl celluloses.

(X) The photosensitive resin composition as described in any one of (I) to (IX), which contains an amine (F).

(XI) The photosensitive resin composition as described in (X), wherein the amine (F) is a tertiary amine and has a cyclic structure.

(XII) The photosensitive resin composition as described in (X), wherein the amine (F) is a morpholine-type amine.

(XIII) The photosensitive resin composition as described in any one of (I) to (XII), wherein the content of the water (C) is from 20 to 80 mass % of the photosensitive resin composition.

(XIV) The photosensitive resin composition as described in any one of (I) to (XIII), wherein the thixotropic agent (D) is a silicate mineral.

(XV) The photosensitive resin composition as described in (XIV), wherein the thixotropic agent (D) is an amine-modified silicate mineral.

(XVI) The photosensitive resin composition as described in any one of (I) to (XV), wherein the content of the thixotropic agent (D) is from 0.1 to 5 mass % of the photosensitive resin composition.

(XVII) The photosensitive resin composition as described in any one of (I) to (XVI), which contains a solvent (G) other than water, having at least one or more hydroxyl group and wherein the content of the solvent (G) is from 5 to 40 mass % of the photosensitive resin composition.

(XVIII) The photosensitive resin composition as described in any one of (I) to (XVII), wherein the viscosity is from 30 to 180 mPa·s at 25° C.

(XIX) The photosensitive resin composition as described in any one of (I) to (XVIII), wherein the surface tension is 35 mN/m or less at 25° C.

(XX) The photosensitive resin composition as described in any one of (I) to (XIX), which contains a surfactant (H).

(XXI) The photosensitive resin composition as described in any one of (I) to (XIX), wherein a flammable liquid content is 40 mass % or less of the photosensitive resin composition, a flash point of the composition is 60.5° C. or more and the burning point is 80° C. or more.

(XXII) A process for producing a photosensitive resin film, comprising the steps of:

dipping an insulating substrate having thereon an electrically conductive metal layer in the photosensitive resin composition described in any one of (I) to (XXI)

pulling up the substrate from the photosensitive resin composition, and

drying the photosensitive resin composition on the substrate.

(XXIII) The process for producing a photosensitive resin film as described in (XXII), wherein the lifting speed at the step of pulling up the substrate from the photosensitive resin composition is reduced on the way of pulling up the substrate.

(XXIV) The process for producing a photosensitive resin film as described in (XXII) or (XXIII), wherein at the step of pulling up the substrate from the photosensitive resin composition, the initial lifting speed is from 1 to 20 mm/second and thereafter, the lifting speed is reduced to 0.1 to 5 mm/second.

(XXV) The process for producing a photosensitive resin film as described in any one of (XXII) to (XXIV), wherein the photosensitive composition is set at a temperature of 20 to 50° C.

(XXVI) The process for producing a photosensitive resin film as described in any one of (XXII) to (XXV), wherein the photosensitive composition is overflowed from a container and the overflowed photosensitive composition is circulated again to the container.

(XXVII) A process for producing a printed wiring board, comprising

producing a photosensitive resin film by the process described in any one of (XXII) to (XXVI),

subjecting the film to exposure of a desired pattern and development with water or an alkaline solution,

etching the electrically conductive metal layer except for the pattern with an etching solution, and

peeling off the pattern.

(XXVIII) A printed wiring board produced by the process according to (XXVII).

### BEST MODE FOR CARRYING OUT THE INVENTION

The photosensitive resin composition, the process for producing a photosensitive resin film, the process for producing a printed wiring board and the printed wiring board of the present invention are described in detail below. In the following, molecular weights of polymers indicate weight-average molecular weights.

The compound (A) having two or more polymerizable unsaturated bonds within one molecule may be sufficient if it has a polymerizable carbon-carbon double bond of causing a polymerization reaction by a photopolymerization initiator, and a known substance or a reactant of a plurality of known substances may be used. Fundamentally, this compound can be obtained by reacting a compound having two or more reactive functional groups with an unsaturated compound having a functional group capable of reacting with the compound having two or more reactive functional groups. Examples thereof include

(1) a compound produced by reacting a compound having at least two or more hydroxyl groups within one molecule

with an unsaturated monocarboxylic acid (i) through esterification,

with an unsaturated monocarboxylic acid halide (ii),

with an unsaturated monoepoxy (iii) or

with an unsaturated monoisocyanate (iv);

(2) a compound produced by reacting a compound having at least two or more epoxy groups within one molecule

with an unsaturated monocarboxylic acid (i) or

with a hydroxyl group-containing unsaturated compound (v);

(3) a compound produced by reacting a compound having at least two or more carboxylic acids within one molecule

with an unsaturated monoepoxy (iii),

with an unsaturated monoisocyanate (iv) or

with a hydroxyl group-containing unsaturated compound (v);

(4) a compound produced by reacting a compound. having at least two or more acid anhydrides within one molecule

with a hydroxyl group-containing unsaturated compound (v) or

with an unsaturated monoepoxy (iii);

(5) a compound produced by reacting a compound having at least two or more isocyanate groups within one molecule

with a hydroxyl group-containing unsaturated compound (v); and

(6) a compound produced by reacting a compound having at least two or more primary amines within one molecule

with an unsaturated monocarboxylic acid (i),

with an unsaturated monocarboxylic acid halide (ii),

with an unsaturated monoepoxy (iii) or

with an unsaturated monoisocyanate (iv).

In these photosensitive resins, the number of polymerizable unsaturated bonds present within one molecule can be arbitrarily adjusted by controlling the number of functional groups reacted. The compound having two or more reactive functional groups may be a low molecular weight compound or a high molecular weight compound. One of these compounds may be used alone or a plurality of the compounds may be also used.

Examples of the compound having at least two or more hydroxyl groups within one molecule, which is used in (1), include alkyl polyols, polyester polyols, polyether polyols, acryl polyols, polybutadiene polyols, silicon-modified polyols, phenolic polyols and/or flame resistant polyols or terminal hydroxyl group-containing urethane polymers.

Examples of the alkyl polyol include ethylene glycol, glycerol, 1,2-propanediol, 1,3-propanediol, 1,4-propanediol, 1,4-butanediol, 1,6-hexanediol, 1,8-octanediol, neopentyl glycol, cyclohexane dimethanol, trimethylol propane, pentaerythritol and ethoxylated pentaerythritol.

Examples of the polyester polyol include condensed-type polyester polyols, addition-polymerized polyester polyols and polycarbonate polyol. The condensed-type polyester polyol is obtained, for example, by the condensation reaction of a diol compound with an organic polybasic acid such as adipic acid, isophthalic acid, terephthalic acid and sebacic acid, and preferably has a molecular weight of 1,000 to 100,000, more preferably of 1,000 to 20,000, even more preferably of 1,500 to 18,000, and most preferably of 2,000 to 15,000. Examples of the diol compound include ethylene glycol, propylene glycol, diethylene glycol, 1,4-butanediol, neopentyl glycol, 1,6-hexanediol, 3-methyl-1,5-pentanediol, 1,9-nonanediol, 1,4-hexanedimethanol, dimer acid diol and polyethylene glycol.

Examples of the addition-polymerized polyester polyol include polycaprolactone, and the molecular weight thereof is preferably from 100 to 100,000. The polycarbonate polyol is synthesized by the direct phosgenation of polyol or the transesterification with a diphenyl carbonate and preferably has a molecular weight of 100 to 100,000.

Examples of the polyether polyol include PEG (polyethylene glycol)-type, PPG (polypropylene glycol)-type and PTG (polytetramethylene glycol)-type polyols, such as diethylene glycol, triethylene glycol, tetraethylene glycol, dipropylene glycol, tripropylene glycol and tetrapropylene glycol.

Examples of the polyether polyol other than the above-described polyether polyols include an ethylene oxide adduct or propylene oxide adduct of bisphenol A.

Examples of other polyols include (meth)acrylpolyols which are a copolymer of a hydroxyl group-containing (meth)acrylate such as 2-hydroxyethyl (meth)acrylate, hydroxypropyl (meth)acrylate, hydroxybutyl (meth)acrylate, polyethylene glycol mono(meth)acrylate, glycerol di(meth)acrylate, trimethylolpropane di(meth)acrylate, pentaerythritol tri(meth)acrylate or dipentaerythritol penta(meth)acrylate, with a (meth)acrylate other than these or with a styrene; polybutadiene polyols as a copolymerization product of butadiene, which are a homo- or copolymer having a hydroxyl group at the terminal; silicon-modified polyols; phenolic polyols containing a phenol molecule within the molecule; novolak resins; epoxy polyols; and flame resistant polyols containing a phosphorus atom, a halogen atom or the like.

Examples of the terminal hydroxyl group-containing urethane polymer include those obtained by reacting the above-described polyols with an organic polyisocyanate. Examples of the organic polyisocyanate include 2,4- and/or 2,6-tolylene diisocyanate, 4,4′-diphenylmethane diisocyanate (MDI), hexamethylene diisocyanate, trimethylhexamethylene diisocyanate, isophorone diisocyanate, xylylene diisocyanate, hydrogenated MDI and hydrogenated xylylene diisocyanate. These polyol compounds can be used individually or in combination of two or more thereof.

Other examples of the polyol include vinyl alcohol-type polymerization products such as partially saponified vinyl acetate, completely saponified vinyl acetate and partially saponified compound of a copolymer of vinyl acetate and ethylene or the like; poly-p-hydroxystyrene; and modified products thereof.

Examples of (i) the unsaturated monocarboxylic acid include a (meth)acrylic acid, a dimer of acrylic acid, a styrylacrylic acid, a β-furfurylacrylic acid, a crotonic acid, an α-cyanocinnamic acid and a cinnamic acid.

Examples of (ii) the unsaturated monocarboxylic acid halide include a (meth)acryloyl chloride.

Examples of (iii) the unsaturated monoepoxy include a glycidyl (meth)acrylate and M100, A200 and M101 (produced by Daicel Chemical Industries, Ltd.).

Examples of (iv) the unsaturated monoisocyanate include a 2-isocyanatoethyl methacrylate and a reactant obtained by reacting an organic diisocyanate (for example, tolylene diisocyanate, xylylene diisocyanate, isophorone diisocyanate or hexamethylene diisocyanate) with the above-described (meth)acrylate having one hydroxyl group within one molecule, approximately in an equimolar ratio.

Examples of the compound (A), having two or more polymerizable unsaturated bonds within one molecule, obtained from a compound having at least two or more hydroxyl groups within one molecule as described above include polyethylene glycol-type polyols such as tetraethylene glycol, and compounds obtained by reacting pentaerythritol, dipentaerythritol, ethoxylated pentaerythritol, propoxylated trimethylol propane with (meth)acrylic acid or (meth)acrylic acid chloride; these examples are preferable since they are relatively compatible with water.

Specific examples include “INK ESTERS” (A-200, A-400, A-600, AG-4, AG-14, and AG-23) manufactured by SHIN-NAKAMURA CHEMICAL CO., LTD., and “SR SERIES” (SR-259, 268, 272, 415, 454, 492, 494, 502, 9020) manufactured by NIPPON KAYAKU CO., LTD.

Examples of the compound (2) having at least two or more epoxy groups within one molecule include novolak-type epoxy resins (for example, a resin obtained by reacting epichlorohydrin and/or methylepichlorohydrin with a novolak obtained by the reaction of a phenol such as phenol, cresol, halogenated phenol or alkylphenol with formaldehyde in the presence of an acid catalyst, and examples of the commercially available product include FOCN-103, FOCN-104S, FOCN-1020, FOCN-1027, FPPN-201 and BRFN-S produced by Nippon Kayaku Co., Ltd.; EFN-431 and EFN-439 produced by Dow Chemical; and N-730, N-770, N-865, N-665, N-673, N-695 and VH-4150 produced by Dai-Nippon Ink & Chemicals, Inc.), bisphenol-type epoxy resins (for example, a resin obtained by reacting epichlorohydrin and/or methylepichlorohydrin with a bisphenol such as bisphenol A, bisphenol D, bisphenol S or tetrabromobisphenol A, and a resin obtained by reacting epichlorohydrin and/or methylepichlorohydrin with a condensate of a diglycidyl ether of bisphenol A to the above-described bisphenol, and examples of the commercially available product include Epicote 1004 and Epicote 1002 produced by Yuka-Shell Epoxy Co., Ltd.; and EFR-330 and EFR-337 produced by Dow Chemical), trisphenolmethane-type epoxy resins (for example, a resin obtained by reacting epichlorohydrin and/or methylepichlorohydrin with trisphenolmethane, triscresolmethane or the like, and examples of the commercially available product include FPPN-501 and FPPN-502 produced by Nippon Kayaku Co., Ltd.), a tris(2,3-epoxypropyl) isocyanurate, a biphenyl diglycidyl ether, alicyclic amino group-containing epoxy resins (for example, CEROXIDE 2021 produced by Daicel Chemical Industries, Ltd.; EPOMIC VG-3101 produced by Mitsui Chemicals, Inc.; F-1031S produced by Yuka-Shell Epoxy Co., Ltd.; TFTRAE-X and TFTRAE-C produced by Mitsubishi Gas Chemical Industries Ltd.; FPB-13 and FPB-27 produced by Nippon Soda Co., Ltd.), copolymerization-type epoxy resins (for example, CP-50M and CP-50S produced by NOF Corporation, which are a copolymer of glycidyl methacrylate and styrene and a copolymer of glycidyl methacrylate, styrene and methyl methacrylate; and a copolymer of glycidyl methacrylate and cyclohexylmaleimide or the like) and epoxy resins having other specific structures. Among these, preferred are a cresol novolak-type epoxy resin and a phenol novolak-type epoxy resin.

Examples of (v) the hydroxyl group-containing unsaturated compound include 2-hydroxyethyl (meth)acrylate, hydroxypropyl (meth)acrylate, hydroxybutyl (meth)acrylate, polyethylene glycol mono(meth)acrylate, glycerol di(meth)acrylate, trimethylolpropane di(meth)acrylate, pentaerythritol tri(meth)acrylate and dipentaerythritol penta(meth)acrylate.

Examples of the compound (A), having two or more polymerizable unsaturated bonds within one molecule, obtained from a compound having at least two or more epoxy groups within one molecule as described above include bisphenols and (meth)acrylic acid adducts of a condensate between a bisphenol and diglycidyl ether; these examples are preferable in view of water resistance of a coating film thereof.

Specific examples include epoxy esters (3000A, 3000M, 3002A, 3002M) manufactured by KYOEISHA CHEMICAL CO.,LTD., “NEOPOL SERIES” manufactured by Japan U-PiCA Company, Ltd., and “PR-9”, “PR-20”, and “PNA SERIES” manufactured by NIPPON KAYAKU CO., LTD.

Examples of the compound (3) having at least two or more carboxylic acids within one molecule include dicarboxylic acid compounds such as maleic acid, succinic acid, itaconic acid, phthalic acid, tetrahydrophthalic acid, hexahydrophthalic acid, methylhexahydrophthalic acid, endomethylenetetrahydrophthalic acid, methyl endomethylene-tetrahydrophthalic acid, chlorendic acid and methyl tetrahydrophthalic acid; aromatic polyvalent carboxylic acid compounds such as trimellitic acid, pyromellitic acid and benzophenone tetracarboxylic acid; and compounds associated therewith, for example, polyvalent carboxylic acid derivatives such as 5-(2,5-dioxotetrahydrofuryl)-3-methyl-3-cyclohexene-1,2-dicarboxylic acid, (meth)acrylic acid, and polymerization products of a (meth)acrylic acid ester and other polymerizable monomer. Among these, preferred are a (meth)acrylic acid in view of hydrophilicity.

As examples of the compound (A), having two or more polymerizable unsaturated bonds within one molecule, obtained from a compound having at least two or more carboxyl groups within one molecule as described above, polymers obtained by reacting a copolymer of methacrylic acid and methyl methacrylate with glycidyl acrylate are preferable in view of hydrophilicity. The molecular weight thereof is preferably from 500 to 100,000, more preferably from 1,000 to 20,000, even more preferably from 1,500 to 18,000, and particularly preferably from 2,000 to 15,000.

Examples of the compound (4) having at least two or more acid anhydrides within one molecule include a polymerization product of maleic anhydride and styrene, and a graft polymerization product of polypropylene maleic acid anhydride.

Examples of the compound (5) having at least two or more isocyanate groups within one molecule include a copolymer of 1,6-diisocyanatohexane, 1,8-diisocyanatooctane, 1,10-diisocyanatodecane, 1,12-diisocyanatododecane or 2-isocyanatoethyl methacrylate with other polymerizable monomer.

Examples of the compound (6) having at least two or more primary amino groups within one molecule include 1,2-ethylenediamine, 1,3-propylenediamine, 1,8-diamino-octane, 1,4-phenylenediamine and 1,3-phenylenediamine.

The compound having two or more polymerizable unsaturated bonds and one or more carboxyl group within one molecule includes the compounds (3) and (4) above. The number of carboxylic groups can be adjusted by controlling the number of reactive functional groups. The acid value is preferably from 5 to 200 mgKOH/g, more preferably from 50 to 150 mgKOH/g.

Particularly preferred examples include a polymer compound obtained by reacting an unsaturated monoepoxy compound such as glycidyl acrylate with a copolymer of methacrylic acid and a methacrylic acid ester such as methyl methacrylate. The molecular weight thereof is preferably from 500 to 100,000, more preferably from 1,000 to 20,000, even more preferably from 1,500 to 18,000, and particularly preferably from 2,000 to 15,000.

The compound not having a carboxylic group and having two or more polymerizable unsaturated bonds within one molecule includes the compounds (1), (2), (5) and (6) above.

Particularly preferred examples include a compound obtained by reacting an acrylic acid with a copolymer of methyl methacrylate and glycidyl methacrylate, a reactant of bisphenol A and acrylic acid, and a reactant of bisphenol A and glycidyl acrylate. The molecular weight thereof is preferably from 100 to 10,000, more preferably from 200 to 10,000, even more preferably from 300 to 3,000, and particularly preferably from 400 to 2,000.

Depending on the use end, the photosensitive composition where only a compound (A′) having a carboxylic group is contained as the compound (A) having two or more polymerizable unsaturated bonds shows insufficient water resistance even when photo-cured, for example, the film swells and strips at the development with water or an alkaline solution. In this case, a small amount of a compound (A″) not having a carboxylic group and having two or more polymerizable unsaturated bonds within one molecule is added, whereby the water resistance is improved and even if the film is developed with water or an alkaline solution, the film exerts the water resistance and can endure etching.

In the case where a compound (A″) not having a carboxylic group and having two or more polymerizable unsaturated bonds within one molecule and a compound (A′) having a carboxylic group and having two or more polymerizable unsaturated bonds within one molecule are contained in the photosensitive composition, the weight ratio therebetween is preferably from 1:20 to 1:1, more preferably from 1:15 to 1:1.

In the photosensitive composition, the content of the compound (A) having two or more polymerizable unsaturated bonds within one molecule is preferably from 5 to 50 mass %. If the content is less than 5 mass %, the film thickness decreases and this causes a problem such as reduction in the film strength, whereas if it exceeds 50 mass %, the film thickness increases and there arises a problem, for example, the viscosity is extremely elevated or the drying takes time. The content is more preferably from 10 to 30 mass %.

The photosensitive composition of the present invention may contain an amine (F). In the case where the compound (A) having two or more polymerizable unsaturated bonds within one molecule is a compound (A′) having one or more carboxylic group within one molecule, it is particularly preferable that an amine (F) be added so as to stably disperse or dissolve the compound (A′) in a solvent such as water.

As the amine (F), a known amine can be used. Examples thereof include ammonia, diethylamine, monoethylamine, diisopropylamine, diisobutylamine, triethylamine, monoethanolamine, diethanolamine, dimethylethanolamine, triethanolamine, N-methylmorpholine, N-ethylmorpholine, N-phenylmorpholine and cyclohexylamine. In view of storage stability, the amine (F) is preferably a tertiary amine or an amine having a cyclic structure (the cyclic structure including a nitrogen atom), and more preferably is an amine having a cyclic structure (the cyclic structure including a nitrogen atom). Even more preferably, the amine (F) is a tertiary amine having a cyclic structure, for example, a morpholine-type amine such as N-methylmorpholine, N-ethylmorpholine or N-phenylmorpholine, using which the dispersed state of each component in the composition according to the present invention can be kept stabilized for a longer time.

The amount of amine (F) added is not particularly limited, however, an amount large enough to disperse the compound having a carboxylic group is preferred and the amine is preferably added in an amount equivalent to or less than the carboxylic groups in the photosensitive composition. Specifically, the amount of amine (F) is from 0.2 to 1.0 equivalents with respect to 1 equivalent of carboxylic groups, more preferably from 0.4 to 1.0 equivalents, and even more preferably from 0.6 to 1.0 equivalents.

The content of water (C) is preferably from 20 to 80 mass %. If the content of water is less than 20 mass %, the flash point decreases, whereas if it exceeds 80 mass %, dispersion failure may occur. The content of water (C) is more preferably from 25 to 60 mass %, and particularly preferably from 30 to 50 mass %.

The photopolymerization initiator (B) is not particularly limited and a known photopolymerization inhibitor can be used. Examples thereof include acetophenones such as acetophenone, 2,2-dimethoxy-2-phenylacetophenone, 2,2-diethoxy-2-phenylacetophenone, P-dimethylaminopropiophenone, dichloroacetophenone, trichloroacetophenone, p-tert-butyl-trichloroacetophenone, 1-hydroxycyclohexylphenyl ketone, 2-methyl-1-[4-(methylthio)phenyl]-2-morpholino-propan-1-one, 2-benzyl-2-dimethylamino-1-(4-morpholinophenyl)-butanone-1 and N,N-dimethylaminoacetophenone; benzophenones such as benzophenone, methylbenzophenone, 2-chlorobenzophenone, 4,4′-dichlorobenzophenone, 4,4′-bisdimethylaminobenzophenone, 4,41-bisdiethylaminobenzophenone, Michler's ketone and 4-benzoyl-4′-methyldiphenylsulfide; benzoin ethers such as benzyl, benzoin, benzoin methyl ether, benzoin ethyl ether, benzoin isopropyl ether and benzoin isobutyl ether; ketals such as acetophenone dimethyl ketal and benzyl dimethyl ketal; thioxanthones such as thioxanthone, 2-chlorothioxanthone, 2,4-dimethylthioxanthone, 2,4-diethylthioxanthone and 2,4-diisopropylthioxanthone; anthraquinones such as 2-methylanthraquinone, 2-ethylanthraquinone, 2-tert-butylanthraquinone, 1-chloroanthraquinone, 2-aminoanthraquinone and 2,3-diphenylanthraquinone; organic peroxides such as benzoyl peroxide and cumene peroxide; thiol compounds such as 2,4,5-triarylimidazole dimer, riboflavin tetrabutyrate, 2-mercaptobenzimidazole, 2-mercaptobenzoxazole and 2-mercaptobenzothiazole; organic halogen compounds such as 2,4,6-tris-S-triazine, 2,2,2-tribromoethanol and tribromomethylphenylsulfone; and 2,4,6-trimethylbenzoyl diphenylphosphine oxide. These compounds can be used individually or in combination of two or more thereof. Furthermore, this photopolymerization initiator (B) can be used in combination with one or more of photosensitizers such as ethyl N,N-dimethylaminobenzoate, isoamyl N,N-dimethyl-aminobenzoate, pentyl-4-dimethylaminobenzoate and tertiary amines (e.g., triethylamine, triethanolamine).

Preferred combinations of those photopolymerization initiators (B) are a combination of 2-methyl-1-[4-(methylthio)phenyl]-2-morpholino-propan-1-one (for example, Irgacure 907 produced by Ciba-Geigy) with 2-chlorothioxanthone (for example, KAYACURE CTX produced by Nippon Kayaku Co., Ltd.), 2,4-diethylthioxanthone (for example, KAYACURE EFTX produced by Nippon Kayaku Co., Ltd.), 2-isopropylthioxanthone, 4-benzoyl-4′-methyldiphenylsulfide or the like. The photopolymerization initiator (B) is suitably used in an amount of giving a ratio of 0.2 to 30 mass %, preferably from 1 to 10 mass %, per 100 mass % of the photosensitive resin. If the ratio of the photopolymerization initiator (B) blended is less than 0.2 mass %, the photo-curability is deteriorated, whereas if it exceeds 30 mass %, the properties of the cured film are worsened or the composition is disadvantageously deteriorated in the storage stability and becomes difficult to disperse in a solvent containing water.

The thixotropic agent (D) means a material of imparting thixotropic properties to the photosensitive composition.

The thixotropic agent (D) is not particularly limited and a known thixotropic agent can be used. Examples thereof include inorganic compounds such as calcium stearate, zinc stearate, aluminum stearate, aluminum oxide, zinc oxide, magnesium oxide, glass, diatomaceous earth, titanium oxide, zirconium oxide, silicon dioxide, talc, mica, feldspar, kaolinite (kaolin clay), pyrophyllite (agalmatolite clay), sericite, bentonite, smectite-vermiculites (e.g., montmorillonite, beidellite, nontronite, saponite), organic bentonite and organic smectite; and organic compounds obtained by pulverizing a fatty amide wax, a polyethylene oxide, an acrylic resin, an amine salt of polymer polyester, a salt of linear polyaminoamide with polymeric acid polyester, an amide solution of polycarboxylic acid, an alkyl sulfonate, an alkylallyl sulfonate, a colloidal-type ester, a polyester resin, a phenol resin, a melamine resin, an epoxy resin, a urethane resin or a polyimide resin. These may be used individually or in combination of two or more thereof.

Examples of the commercially available inorganic compound which can be used as the thixotropic agent (D) include Crown Clay, Burgess Clay #60, Burgess Clay KF, Opti-White (produced by Shiraishi Kogyo Kaisha, Ltd.), Kaolin JP-100, NN Kaolin Clay, ST Kaolin Clay, Hardsil (produced by Tsuchiya Kaolin Kogyo K.K.), ASP-072, Satintonplus, Translink 37, Hydrous-delami NCD (produced by Angel Hard Corporation), SY Kaolin, OS Clay, HA Clay, MC Hard Clay (produced by Maruo Calcium Co., Ltd.), Rucentite SWN, Rucentite SAN, Rucentite STN, Rucentite SEN, Rucentite SPN (produced by Co-op Chemical K.K.), Smecton (produced by Kunimine Kogyo K.K.), Ben-gel, Ben-gel FW, Es-ben, Es-ben 74, Organite, Organite T (produced by Hojun K.K.), Hotaka Jirushi, Orben, 250 M, Benton 34, Benton 38 (produced by Wilbur Elis K.K.), Laponite, Laponite RD and Laponite RDS (produced by Nippon Silica Kogyo K.K.).

Examples of the commercially available organic compound which can be used as the thixotropic agent (D) include Disparon #6900-20X, Disparon #4200, Disparon KS-873N, Disparon #1850 (produced by Kusumoto Kasei K.K.), BYK-405, BYK-410 (produced by PYC Chemie Japan Co.) Primal RW-12W (produced by Rohm and Haas Co.) and A-S-AT-20S, A-S-AT-350F, A-S-AD-10A and A-S-AD-160 (produced by Ito Seiyu K.K.). The compound may be dispersed in a solvent.

Among these, in view of suitability for application on printed boards, examples of preferred thixotropic agent (D) include silicate compounds represented by xM(I)₂O.ySiO₂ (some compounds correspond to M(II)O and M(III)₂O₃ having an oxidation number of 2 or 3; x and y each represents a positive number), and examples of more preferred thixotropic agent (D) include swelling layer clay minerals such as hectolite, bentonite, smectite and vermiculite.

In particular, an amine-modified silicate mineral (organic smectite; a silicate mineral where an interlayer cation such as sodium is exchanged by an organic amine compound) can be suitably used as the thixotropic agent (D). Examples thereof include those where a sodium ion of sodium magnesium silicate (hectolite) is exchanged by the following ammonium ion. Examples of the ammonium ion include monoalkyl trimethyl ammonium ion, dialkyl dimethyl ammonium ion and trialkyl methyl ammonium ion, each having an alkyl chain with 6 to 18 carbon atoms; dipolyoxyethylene coconut oil alkylmethyl ammonium ion and bis(2-hydroxyethyl) coconut oil alkylmethyl ammonium ion, each having an oxyethylene chain with 4 to 18 carbon atoms; and polyoxypropylenemethyl diethyl ammonium ion having an oxopropylene chain with 4 to 25 carbon atoms. These ammonium ions can be used individually or in combination of two or more thereof.

As for the production method for amine-modified silicate minerals where a sodium ion of sodium magnesium silicate (hectolite) is exchanged by an ammonium ion, sodium magnesium silicate is dispersed in water, thoroughly stirred and then left standing for 16 hours or more to prepare a 4 mass % dispersion solution. While stirring this dispersion solution, a desired ammonium salt is added in an amount of 30 to 200 mass % based on the sodium magnesium silicate. After the addition, cation exchange occurs and hectolite containing the ammonium salt between layers becomes insoluble in water and precipitates, so that an amine-modified silicate mineral can be obtained by filtrating the precipitate and drying it. At the preparation, the dispersion solution may be heated so as to accelerate the dispersion.

Examples of the commercially available amine-modified silicate minerals include Rucentite SAN, Rucentite STN, Rucentite SEN and Rucentite SPN (produced by Co-op Chemical Co., Ltd.). These may be used individually or in combination of two or more thereof.

The value which indicates the degree of thixotropy (the degree hereinafter referred to as “thixotropy index”) can be expressed as a ratio of viscosities determined using a rotational viscometer at different speeds of rotation. This thixotropy index is very critical to an aqueous photosensitive composition for dip coating.

As the method for measuring a thixotropy index, a commercially available rotational viscometer can be used. For example, an E-type viscometer “VISCONIC, TYPE ED”) manufactured by Tokimec, Inc. can be used.

If this value is lower than a specific value, liquid dripping of the photosensitive resin composition coated on the board occurs during drying, whereby formation of film having a uniform thickness is hindered.

It is preferable that the thixotropy index of the aqueous photosensitive resin composition according to the present invention as the ratio of the viscosity at 60 rpm with respect to that at 6 rpm at 25° C. be 1.1 to 5.0. If this index is less than 1.1, the composition applied to the board tends to cause liquid dripping, whereas if this index is too high, the fluidity becomes undesirable and unevenness in coating occurs.

The content of the thixotropic agent (D) is preferably from 0.1 to 5 mass %. If the content is less than 0.1 mass %, the thixotropic property hardly comes out, whereas if it exceeds 5 mass %, the viscosity is high and the film thickness is too large. The content is more preferably from 0.3 to 2 mass %.

In order to improve the dispersibility and solubility of the photosensitive composition, a solvent (G) other than water can be appropriately added. The kind thereof is not particularly limited and a known solvent may be used, however, a solvent having at least one or more hydroxyl group is preferably contained. Examples thereof include methanol, ethanol, 1-propanol, isopropanol, 1-butanol, 1-pentanol, 3-methoxy-3-methylbutanol, ethylene glycol, propylene glycol, glycerol, 1,2-propanediol, 1,3-propanediol, 1,4-propanediol, diethylene glycol, triethylene glycol, tetraethylene glycol, ethylene glycol methyl ether, ethylene glycol ethyl ether, ethylene glycol butyl ether, diethylene glycol methyl ether, diethylene glycol ethyl ether, diethylene glycol butyl ether, triethylene glycol methyl ether, triethylene glycol ethyl ether, triethylene glycol butyl ether, ethylene glycol acetate, diethylene glycol acetate, triethylene glycol acetate, propylene glycol methyl ether, propylene glycol ethyl ether, propylene glycol propyl ether, propylene glycol butyl ether, dipropylene glycol methyl ether, dipropylene glycol ethyl ether, dipropylene glycol propyl ether, dipropylene glycol butyl ether, propylene glycol acetate, dipropylene glycol acetate, lactic acid, methyl lactate and ethyl lactate.

The content of the solvent (G), having at least one or more hydroxyl groups, is preferably from 5 to 40 mass %. If the content exceeds 40 mass %, the flash point decreases, whereas if it is less than 5 mass %, the solution or dispersion state of the photosensitive composition becomes unstable.

The viscosity of the photosensitive resin composition of the present invention is preferably from 30 to 180 mPa·s at 25° C. If the viscosity is low, the thixotropic property is hardly exerted, whereas if it is too high, the film thickness becomes too large. The viscosity is more preferably from 50 to 130 mPa·s. As the method for measuring a viscosity, a commercially available rotational viscometer can be used. For example, an E-type viscometer (VISCONIC ED) manufactured by Tokimec, Inc. can be used.

The surface tension of the photosensitive resin composition of the present invention is preferably 35 mN/m or less at 25° C. If the surface tension exceeds 35 mN/m, the wettability to a printed wiring board is deteriorated. The method for adjusting the surface tension to 35 mN/m or less is not particularly limited and examples thereof include a method of using a solvent having a relatively small surface tension and a method of adding a surfactant (H).

The method for measuring the surface tension is not particularly limited and a commercially available surface tension balance can be used. For example, an automatic surface tension balance manufactured by Kyowa Interface Science Co., Ltd. can be used, and the measurement conditions are 25° C. and atmospheric pressure.

The surfactant (H) is not particularly limited and a known surfactant can be used. Examples thereof include anionic surfactants (e.g., sodium dodecylbenzenesulfonate, sodium laurate, ammonium salt of polyoxyethylene alkyl ether sulfate), nonionic surfactants (e.g., polyoxyethylene alkyl ether, polyoxyethylene alkyl ester, polyoxyethylene sorbitan fatty acid ester, polyoxyethylene alkylphenyl ether, polyoxyethylene alkylamine, polyoxyethylene alkylamide) and acetylene glycol-base surfactants. In the present invention, these surfactants may be used individually or in combination of two or more thereof.

Examples of surfactants (H) which are commercially available include Emal Series, Neopelex Series, Pelex Series, Latemul Series, Demol Series, Poiz Series, Monogenol Series, Emulgen Series, Rheodol Series, Emasol Series, Excel Series, Emanon Series, Amiet Series, Acetamin Series, Quartamin Series, Sanisol Series (produced by Kao Corporation), Adekacol CC Series (produced by Asahi Denka Kogyo K.K.), Nonipol Series, Octapol Series, Dodecapol Series, Emulmin Series, Nonipol Soft Series, Ionet Series, Profan Series, Eleminol Series, Newpol Series, Sedran Series, Cation Series, Lebon Series (produced by Sanyo Chemical Industries, Ltd.), Unidyne (produced by Daikin Industries, Ltd.), Megafac Series (produced by Dainippon Ink & Chemicals, Inc.), Leoguard Series (produced by Lion Corporation), Silwet Series (produced by Nippon Unicar) and Surfinol Series (produced by Air Products Japan).

The “stabilizing agent” herein is a compound which has a function of preventing the composition of the present invention from flocculating, and when the composition of the present invention is in a heterogeneous system, the stabilizing agent can improve the dispersion stability thereof. Specific examples of the stabilizing agents which can be used are unlimited types of known compounds which can form a surfactant or protective colloid. More specifically, a water-soluble or hydrophilic polymer, such as a polyvinyl alcohol, modified polyvinyl alcohol, partially saponified copolymer of ethylene and vinyl acetate, hydroxyethyl cellulose, polyglycerin, polyethylene glycol, polypropylene glycol, and polyvinyl pyrrolidone, can be used. Among these, water-soluble polymers, such as a polyvinyl alcohol, modified polyvinyl alcohol, partially saponified copolymer of ethylene and vinyl acetate, hydroxyethyl cellulose, and polyglycerin, are preferred since they can impart sufficient effects even if they are used in a small amount. A polyvinyl alcohol, modified polyvinyl alcohol, and partially saponified copolymer of ethylene and vinyl acetate are most preferred. The molecular weight of these compounds is normally from 200 to 1,000,000, preferably from 1,000 to 100,000, and particularly preferably from 5,000 to 50,000. According to the present invention, one or more stabilizing agents (E) may be used. The content of the stabilizing agent (E) is preferably from 0.001 to 5 mass %. More preferably, the content of the stabilizing agent (E) is from 0.01 mass % to 0.5 mass %. If the content of the stabilizing agent is less than 0.001 mass %, the dispersion stability cannot be improved, whereas if the content exceeds 5 mass %, the sensitivity and the resolution may be degraded.

Examples of the stabilizing agents which are commercially available include “KL-318”, “KL-506”, and “PVA-505” (manufactured by Kuraray Co., Ltd.).

In a preferred embodiment of the photosensitive composition of the present invention, the flammable liquid occupies 40 mass % or less in the composition, the flash point is 60.5° C. or more and the burning point is 80° C. or more. The “flammable liquids” herein indicate the dangerous materials in Category 4 (flammable liquids) and the flammable liquids among the designated flammable materials under the Japanese Fire Service Law. Such a photosensitive composition is excepted from the dangerous materials in Category 4 of the Japanese Fire Service Law and also excepted from Class 3 in the United Nations Recommendations on the Transport of Dangerous Goods. The flash point and the burning point can be measured using a Tag closed cup flash tester or a Cleaveland open-cup flash tester. These testers are preferably in accordance with JIS (Japanese Industrial Standards) K2265, or ASTM (American Society for Testing and Materials) D56 or D92.

In the photosensitive composition of the present invention, other known organic solvents may be added, if desired, and examples thereof include ketones such as acetone, methyl ethyl ketone and cyclohexanone; aromatic hydrocarbons such as toluene, xylene, ethylbenzene and tetramethylbenzene; glycol ethers such as ethylene glycol monomethyl ether acetate, ethylene glycol monoethyl ether acetate, ethylene glycol monobutyl ether acetate, propylene glycol monomethyl ether acetate, propylene glycol monoethyl ether acetate, ethylene glycol dimethyl ether, ethylene glycol diethyl ether, ethylene glycol dibutyl ether, diethylene glycol dimethyl ether, diethylene glycol diethyl ether and diethylene glycol dibutyl ether; acetic acid esters such as methyl acetate, ethyl acetate, butyl acetate and 3-methoxy-3-methylbutyl acetate; aliphatic hydrocarbons such as octane, decane and cyclohexane; and petroleum solvents such as petroleum ether, petroleum naphtha, hydrogenated petroleum naphtha and solvent naphtha.

In the photosensitive composition of the present invention, an appropriate polymerization inhibitor is preferably used in combination. For the polymerization inhibitor, a conventionally known inhibitor may be used. Examples thereof include phenols (e.g., 3,5-di-tert-butyl-4-hydroxytoluene), hydroquinones (e.g., hydroquinone, hydroquinone monomethyl ether) and catechols (e.g., catechol, tert-butylcatechol, pyrogallol).

In the photosensitive composition of the present invention, a known inorganic filler such as barium sulfate, barium titanate, powdered silicon oxide, amorphous silica, magnesium carbonate, calcium carbonate, aluminum oxide, aluminum hydroxide, glass fiber and carbon fiber can be added, if desired, for improving the properties such as hardness.

Furthermore, if desired, a known coloring agent such as Acid Blue, Phthalocyanine Blue, Phthalocyanine Green, Iodine Green, Disazo Yellow, Crystal Violet, titanium oxide, carbon black and naphthalene black; a defoaming agent and/or leveling agent of silicone type, fluorine type or polymer type; and an adhesion-imparting agent such as silane coupling agent of imidazole-, thiazole- or triazole-type, may be added.

The insulating substrate having an electrically conductive metal layer is usually called a printed board, a printed wiring board or the like. For the insulating substrate, a substrate obtained by curing an epoxy resin containing glass fibers or a substrate obtained by the solidification of paper/phenol resin or novolak resin can be used. For the electrically conductive metal layer, copper or the like can be used and a known or commercially available product can be used.

For forming a photosensitive resin film on an insulating substrate having thereon an electrically conductive metal layer, a so-called dipping method of charging a photosensitive resin composition into a container, dipping a printed wiring board therein and then pulling it up is preferably used. The device used at this time is not particularly limited and a known device may be used, however, a device where the lifting speed can be controlled is preferred. More preferred is a device where the lifting speed can be changed during the lifting so as to form a uniform film. With respect to the lifting speed, the lifting speed at the lifting initial stage is from 1 to 20 mm/second and then the lifting speed is preferably reduced to the range from 0.1 to 5 mm/second. By controlling the lifting speed as such, the photosensitive composition does not drip from the substrate after pulling up the substrate and a uniform film thickness can be obtained.

In forming a film by the dipping method, the photosensitive composition is preferably at a temperature of 20 to 50° C. By raising the temperature, when the printed board is lifted, the photosensitive composition coated on the printed board is cooled by air, as a result, the viscosity increases and the liquid dripping can be more prevented. By virtue of this effect, the lifting speed of the printed board can be elevated and the productivity can be increased. If the temperature is less than 20° C., the effect of preventing the liquid dripping is small, whereas if it exceeds 50° C., the photosensitive composition is readily deteriorated. The temperature of the photosensitive composition is more preferably from 30 to 45° C.

Furthermore, in forming a film by the dipping method, it is preferred to overflow the photosensitive composition from a container and circulate the overflowed photosensitive composition again to the container. By overflowing the photosensitive composition, foaming is prevented, and the film can be uniformly coated. In addition, by overflowing the photosensitive composition and by circulating the overflowed photosensitive composition, a stream is generated, and the non-uniformity of the viscosity of the composition according to the present invention, which is thixotropic, and the resulting coating unevenness can be prevented. The circulation is performed using a pump or the like and at this time, the photosensitive composition is preferably passed through a filter.

The photosensitive resin composition coated as such by the dipping method is dried using a drier. The drying method is not particularly limited, however, a hot air-type drier or a low pressure drier is preferred. The drying temperature is preferably from 60 to 120° C. If the drying temperature is less than 60° C., the drying takes a long time, whereas if it exceeds 120° C., the photosensitive composition may be deteriorated or thermal polymerization may occur. The drying temperature is more preferably from 70 to 100° C. The pressure may be reduced to 760 Torr (1.01×10⁵ Pa) or lower, but it is preferable in view of productivity that the pressure be reduced to 100 Torr (1.33×10⁴ Pa) or lower. The drying time is not particularly limited and is preferably from 10 to 30 minutes, though this varies depending on the drying temperature and the film thickness. If the drying time is less than 10 minutes, the photosensitive composition is not dried and high tack results, whereas if it exceeds 30 minutes, the photosensitive composition is already satisfactorily dried and there is no meaning in taking time for drying.

In the step of forming a resist image, similarly to other conventional photosensitive resist materials, a mask having drawn thereon a desired pattern is usually superposed on a printed wiring board where a photocurable film is formed. At this time, the printed wiring board may be sandwiched between transparent resins and degassed to eliminate the curing hindrance due to oxygen. The photosensitive composition is then exposed to light at a wavelength of 200 to 600 nm. Preferred examples of the light source include a low-pressure mercury lamp, a medium-pressure mercury lamp, a high-pressure mercury lamp, an extra-high pressure mercury lamp, a metal halide lamp, a xenon lamp, a carbon arc lamp, a chemical lamp, a laser ray and an excimer laser ray.

The development after exposure can be easily performed using water or an alkaline aqueous solution by an ordinary method. The method of the development is not particularly limited, however, a spray method is preferred. The alkali which may be used is not particularly limited but, for example, inorganic alkali compounds such as sodium hydroxide, potassium hydroxide, calcium hydroxide, sodium carbonate and potassium carbonate, and organic amines such as aqueous ammonia, tetramethylammonium hydroxide, triethylamine, dimethylethanolamine and triethanolamine, can be used. The concentration of the alkaline solution is not particularly limited and is determined according to the difference in the dissolution rate between the photo-cured film and the non-cured film, but the concentration is preferably from 0.1 to 5 mass %.

The etching for forming a circuit can be performed using an ordinary acidic etching solution, for example, an aqueous hydrochloric acid solution of cupric chloride. The peeling of the resist film after etching can be performed by using an aqueous solution of any of the alkalis exemplified above for the development. For example, the peeling can be easily performed with a 3% sodium hydroxide solution.

Examples of the commercially available dipping device include Full Automatic Dip Coater AD-7200, Semi-Auto Dip Coater SD-6200 and Five Coater SZC-720 (all manufactured by SAZMA Communication Industry Co., Ltd.).

These dipping devices can be used not only for the dipping method but also for the spray method, the roll coater method, the curtain coater method and the like.

The present invention is described in detail below by referring to Examples and Comparative Examples, however, the present invention is not limited to these examples.

### EXAMPLES

### Example 1

27.6 Parts by mass of Resin A (a glycidyl acrylate-modified resin of methacrylic acid/methyl methacrylate copolymer, weight average molecular weight: about 3,500, acid value=100, a propylene glycol methyl ether 50% solution), 2.2 parts by mass of Resin B (an acrylate-modified bisphenol F resin, weight average molecular weight: about 1000, acid value=0, a propylene glycol methyl ether acetate 65% solution), 5.2 parts by mass of polyethylene glycol #200 diacrylate, 2.8 parts by mass of N-methylmorpholine, 17.0 parts by mass of ethylene glycol butyl ether, 2.4 parts by mass of 2-methyl-1-(4-methylthiophenyl)-2-morpholinopropan-1-one, and 0.7 parts by mass of a polyoxypropylene (oxypropylene=25) methyldiethylamine-modified product of hectolite were mixed to yield a homogeneous solution. To this solution, an aqueous solution obtained in advance by dissolving 0.2 parts by mass of C.I. Acid Blue 9 in 41.9 parts by mass of water were added dropwise for 15 minutes while vigorously stirring the solution; the stirring was further continued for 15 hours. To the thus obtained solution, 0.3 parts by mass of 10% aqueous solution of anion-modified polyvinyl alcohol “KL-506 ®” manufactured by Kuraray Co., Ltd.) was added while stirring, and the stirring was continued for 1 hour. This solution is referred to as “Composition A”. The surface tension of Composition A was 31.2 mN/m at 25° C. The viscosity was measured using an E-type viscometer and found to be 37 mPa·s. In addition, the thixotropy index was 1.5.

### Example 2

23.6 Parts by mass of Resin A (a glycidyl acrylate-modified resin of methacrylic acid/methyl methacrylate copolymer, weight average molecular weight: about 3,500, acid value=100, a propylene glycol methyl ether 50% solution), 2.4 parts by mass of Resin B (an acrylate-modified bisphenol F resin, weight average molecular weight: about 1000, acid value=0, a propylene glycol methyl ether acetate 65% solution), 5.4 parts by mass of polyethylene glycol #200 diacrylate, 2.4 parts by mass of N-methylmorpholine, 19.7 parts by mass of ethylene glycol butyl ether, 2.5 parts by mass of 2-methyl-1-(4-methylthiophenyl)-2-morpholinopropan-1-one, 0.8 parts by mass of diethylthioxanthone, and 0.7 parts by mass of a polyoxypropylene (oxypropylene=25) methyldiethylamine-modified product of hectolite were mixed to yield a homogeneous solution. To this solution, an aqueous solution obtained in advance by dissolving 0.2 parts by mass of C.I. Acid Blue 9 in 42.7 parts by mass of water were added dropwise for 15 minutes while vigorously stirring the solution; the stirring was further continued for 15 hours. To the thus obtained solution, 0.3 parts by mass of 10% aqueous solution of anion-modified polyvinyl alcohol “KL-506 ®” manufactured by Kuraray Co., Ltd.) was added while stirring, and the stirring was continued for 1 hour. This solution is referred to as “Composition B”. The surface tension of Composition B was 26.6 mN/m at 25° C. The viscosity was measured using an E-type viscometer and found to be 42 mPa·s. In addition, the thixotropy index was 1.8.

### Example 3

200 kg solution of the same composition as that in Example 2 was prepared on a larger scale. This solution is referred to as “Composition C”. The surface tension of Composition C was 27.6 mN/m at 25° C. The viscosity was measured using an E-type viscometer and found to be 45 mPa·s. In addition, the thixotropy index was 1.7.

### Comparative Example 1

29 Parts by mass of Resin A, 2.3 parts by mass of Resin B, 5.5 parts by mass of polyethylene glycol #200 diacrylate, 2.5 parts by mass of N,N-dimethylethanolamine, 16.2 parts by mass of 1-butanol, and 2.5 parts by mass of 2-methyl-1-(4-methylthiophenyl)-2-morpholinopropan-1-one were mixed to yield a homogeneous solution. To this solution, an aqueous solution obtained in advance by dissolving 0.2 parts by mass of C.I Acid Blue 9 in 41.8 parts by mass of water were added dropwise for 15 minutes while vigorously stirring the solution; the stirring was further continued for 15 hours. To the thus obtained solution, 0.3 parts by mass of 10% aqueous solution of anion-modified polyvinyl alcohol “KL-506 ®” manufactured by Kuraray Co., Ltd.) was added while stirring, and the stirring was continued for 1 hour. This solution is referred to as “Composition D”. The surface tension of Composition D was 35.7 mN/m at 25° C. The viscosity was measured using an E-type viscometer and found to be 70 mPa·s. In addition, the thixotropy index was 1.05.

### Example 4

30.8 Parts by mass of Resin A, 2.3 parts by mass of Resin B, 5.5 parts by mass of polyethylene glycol #200 diacrylate, 16.2 parts by mass of 1-butanol, 2.5 parts by mass of 2-methyl-1-(4-methylthiophenyl)-2-morpholinopropan-1-one, and 0.7 parts by mass of a polyoxypropylene (oxypropylene=25) methyldiethylamine-modified product of hectolite were mixed to yield a homogeneous solution. To this solution, an aqueous solution obtained in advance by dissolving 0.2 parts by mass of C.I Acid Blue 9 in 41.8 parts by mass of water were added dropwise for 15 minutes while vigorously stirring the solution; the stirring was further continued for 15 hours. To the thus obtained solution, 0.3 parts by mass of 10% aqueous solution of anion-modified polyvinyl alcohol (“KL-506 ®” manufactured by Kuraray Co., Ltd.) was added while stirring, and the stirring was continued for 1 hour. This solution is referred to as “Composition E”. The surface tension of Composition E was 30.7 mN/m at 25° C. The viscosity was measured using an E-type viscometer and found to be 70 mPa·s, In addition, the thixotropy index was 1.5.

### Example 5

200 kg solution was prepared in the same manner as in Example 3 except that ethyleneglycol butyl ether was used in place of the stabilizing agent. This solution is referred to as “Composition F”. The surface tension of Composition F was 29.6 mN/m at 25° C. The viscosity was measured using an E-type viscometer and found to be 48.5 mPa·s. In addition, the thixotropy index was 1.9.

Dip Coating Test 1

In a container having an opening of 60 cm×10 cm and a height of 60 cm, the photosensitive composition was charged. After adjusting the temperature to 25° C., a glass epoxy resin-made copper-cladded substrate having a size of 40 cm×40 cm and a thickness of 1 mm was dipped in the photosensitive composition and lifted at a speed of 3 mm/sec, the lifting speed was reduced to 0.5 mm/sec when the substrate was pulled up to the height of 39 cm, and then the substrate was pulled up to the end. In the case of Compositions A and B, the photosensitive composition did not drip from the lower end of the substrate, however, Composition D dripped. Furthermore, in the case of Composition D, cissing was observed on the edge of the substrate immediately after the dipping, however, in the case of Compositions A and B, cissing was not observed.

In the test using Composition A, the substrate was lifted at a lifting speed of 6 mm/sec at 15° C., the lifting speed was reduced to 0.5 mm/sec when the substrate was pulled up to the height of 39 cm, and then the substrate was pulled up to the end, as a result, the composition dripped from the substrate.

Also, Composition A was kept at 40° C., the substrate was lifted at a speed of 6 mm/sec, the lifting speed was reduced to 0.5. mm/sec when the substrate was pulled up to the height of 39 cm, and then the substrate was pulled up to the end, as a result, the composition did not drip from the substrate.

Furthermore, while keeping Composition A at a temperature of 40° C., the photosensitive composition was overflowed and the overflowed photosensitive composition was circulated again to the container at 200 ml/sec. The substrate was lifted at a speed of 6 mm/sec, the lifting speed was reduced to 0.5 mm/sec when the substrate was pulled up to the height of 39 cm, and then the substrate was pulled up to the end. In the case of not circulating the composition, mottling (variation in the concentration of dye added) due to unevenness of the photosensitive composition was observed, however, when the photosensitive composition was circulated, the unevenness was not observed.

Dip Coating Test 2

A “FIVE COATER FC-7500” manufactured by SAZMA Communication Industry Co.,Ltd., was used for the dip coating test. This coater has a tank having an opening of 60 cm×24 cm and a height of 80 cm, and is equipped with a warm-water circulation device and a heat exchanger which allow heating up to 10 to 50° C. This coater can circulate a solution at the maximum speed of 20 L/minute, and can circulate the solution while allowing the solution in the tank to overflow maintaining its temperature. After charging Composition C in the tank of this coater and adjusting the temperature to 35° C., while the composition was allowed to circulate and overflow at 20 L/minute, a glass epoxy resin-made copper-cladded substrate having a size of 40 cm×50 cm and a thickness of 0.1 mm was dipped in the photosensitive composition and lifted at a speed of 5 mm/sec, the lifting speed was reduced to 0.3 mm/sec when the substrate was pulled up to the height of 39 cm, and then the substrate was pulled up to the end. Then, the coated substrate was dried in a hot air-type drier at 80° C. for 15 minutes. An even coating film without blur was obtained. The same test was carried out except that Composition F was used; a blurry uneven coating film was formed on the surface of the coated substrate obtained.

Uniformity of Film Thickness

After the dipping test using the photosensitive composition at a temperature of 25° C., the substrate was placed in a drier at 80° C. for 15 minutes and dried. Thereafter, the substrate was taken out, cooled to room temperature and then measured on the film thickness of upper part, middle part and lower part. The results are shown in Table 1.

TABLE 1

| | Upper | Middle | Lower |
|---|---|---|---|
| | Part | Part | Part |
| Composition A | 7 μm | 9 μm | 10 μm |
| Composition B | 7 μm | 10 μm | 12 μm |
| Composition D | 4 μm | 8 μm | 17 μm |

In the case of Compositions A and B, the film thickness was almost thoroughly uniform, whereas in the case of Composition D, the film thickness largely dispersed. Storage Stability and Resolution Test Compositions A, B and E each was put in a closed container, stored in a constant temperature chamber at 40° C. and tested on the storage stability and resolution immediately after the preparation and after 5 days. The test was performed as follows. The composition was coated on a substrate by the dipping method, dried at 80° C. for 15 minutes, exposed to metal halide light of 500 mj/cm² while placing a test pattern No. 2 (produced by Hitachi Chemical Co., Ltd.) and a 21-step density tablet (produced by Hitachi Chemical Co., Ltd.) on the substrate, and then developed with 1% sodium carbonate. The remaining step number is shown in Table 2.

TABLE 2

| | |
|---|---|
| Immediately After | |
| Preparation | After 5 Days |

| | Step | Resolution | Step | Resolution |
|---|---|---|---|---|
| | Number | (μm) | Number | (μm) |
| Composition A | 1 to 8 | 30 | 1 to 8 | 30 |
| Composition B | 1 to 8 | 30 | 1 to 8 | 30 |
| Composition E | 1 to 8 | 30 | 1 to 4 | 150 |

In the case of Compositions A and B, the sensitivity was not decreased and the resolution was not changed, however, in the case of Composition E, decrease was observed in the sensitivity and in the resolution due to stripping of the resist film.

After the development, the substrate having coated thereon Composition A or B was dipped in an etching solution comprising 40 parts by mass of anhydrous cupric chloride, 30 parts by mass of concentrated hydrochloric acid and 50 parts by mass of water at room temperature for 20 minutes, as a result, copper was removed excluding the resist film portion. Thereafter, the substrate was dipped in a peeling solution comprising 3 parts by mass of sodium hydroxide and 97 parts by mass of water at room temperature for 1 minute, as a result, the resist film was peeled off.

Measurement of Flash Point

The flash point and the burning point of Composition A were measured using a Tag closed cup flash tester. The results are shown in Table 3.

TABLE 3

| | Flash Point | Burning Point |
|---|---|---|
| Composition A | Not observed until | Not observed until |
| (Example 1) | 80° C. | 97° C. |

The flash point and the burning point of Composition A having a flammable liquid content of 40 mass % or less were both 80° C. or more. Therefore, Composition A does not come under the dangerous material of Category 4 of the Japanese Fire Service Law and also is excepted from Class 3 in the United Nations Recommendations on the Transport of Dangerous Goods.

### INDUSTRIAL APPLICABILITY

By the resin composition of the present invention, a photosensitive resin having a high flash point and a high burning point can be provided while maintaining various properties.

1. A photosensitive resin composition comprising
a compound (A) having two or more polymerizable unsaturated bonds within one molecule,
a photopolymerization initiator (B), water (C) and
a thixotropic agent (D).

2. The photosensitive resin composition according to claim 1, wherein a part or the whole of the compound (A) is a compound (A′) having one or more carboxylic group within one molecule and having two or more polymerizable unsaturated bonds within one molecule.

3. The photosensitive resin composition according to claim 2, wherein the acid value of the compound (A′) is from 5 to 200 mgKOH/g.

4. The photosensitive resin composition according to claim 1, which contains, as the compound (A), a compound (A″) not having a carboxylic group and having two or more polymerizable unsaturated bonds within one molecule and a compound (A′) having one or more carboxylic group within one molecule and having two or more polymerizable unsaturated bonds within one molecule.

5. The photosensitive resin composition according to claim 4, wherein the ratio of the compound (A″) to the compound (A′) is from 1:20 to 1:1.

6. The photosensitive resin composition according to claim 1, wherein the content of the compound (A) is from 5 to 50 mass % of the photosensitive resin composition.

7. The photosensitive resin composition according to claim 1, which contains a stabilizing agent (E).

8. The photosensitive resin composition according to claim 7, wherein the stabilizing agent (E) is a water-soluble polymer.

9. The photosensitive resin composition according to claim 8, wherein the water-soluble polymer is selected from the group consisting of polyvinyl alcohols, modified polyvinyl alcohols, and hydroxyethyl celluloses.

10. The photosensitive resin composition according to claim 1, which contains an amine (F).

11. The photosensitive resin composition according to claim 10, wherein the amine (F) is a tertiary amine and has a cyclic structure.

12. The photosensitive resin composition according to claim 10, wherein the amine (F) is a morpholine-type amine.

13. The photosensitive resin composition according to claim 1, wherein the content of the water (C) is from 20 to 80 mass % of the photosensitive resin composition.

14. The photosensitive resin composition according to claim 1, wherein the thixotropic agent (D) is a silicate mineral.

15. The photosensitive resin composition according to claim 14, wherein the thixotropic agent (D) is an amine-modified silicate mineral.

16. The photosensitive resin composition according to claim 1, wherein the content of the thixotropic agent (D) is from 0.1 to 5 mass % of the photosensitive resin composition.

17. The photosensitive resin composition according to claim 1, which contains a solvent (G) other than water, having at least one or more hydroxyl group and wherein the content of the solvent (G) is from 5 to 40 mass % of the photosensitive resin composition.

18. The photosensitive resin composition according to claim 1, wherein the viscosity is from 30 to 180 mPa·s at 25° C.

19. The photosensitive resin composition according to claim 1, wherein the surface tension is 35 mN/m or less at 25° C.

20. The photosensitive resin composition according to claim 1, which contains a surfactant (H).

21. The photosensitive resin composition according to claim 1, wherein a flammable liquid content is 40 mass % or less of the photosensitive resin composition, a flash point of the composition is 60.5° C. or more and the burning point is 80° C. or more.

22. A process for producing a photosensitive resin film, comprising the steps of:
dipping an insulating substrate having thereon an electrically conductive metal layer in the photosensitive resin composition as recited in claim 1
pulling up the substrate from the photosensitive resin composition, and
drying the photosensitive resin composition on the substrate.

23. The process for producing a photosensitive resin film according to claim 22, wherein the lifting speed at the step of pulling up the substrate from the photosensitive resin composition is reduced on the way of pulling up the substrate.

24. The process for producing a photosensitive resin film according to claim 22, wherein at the step of pulling up the substrate from the photosensitive resin composition, the initial lifting speed is from 1 to 20 mm/second and thereafter, the lifting speed is reduced to 0.1 to 5 mm/second.

25. The process for producing a photosensitive resin film according to claim 22, wherein the photosensitive composition is set at a temperature of 20 to 50° C.

26. The process for producing a photosensitive resin film according to claim 22, wherein the photosensitive composition is overflowed from a container and the overflowed photosensitive composition is circulated again to the container.

27. A process for producing a printed wiring board, comprising
producing a photosensitive resin film by the process as recited in claim 22,
subjecting the film to exposure of a desired pattern and development with water or an alkaline solution,
etching the electrically conductive metal layer except for the pattern with an etching solution, and
peeling off the pattern.

28. A printed wiring board produced by the process according to claim 27.
